(19) United States
(12) Patent Application Publication
(10) Pub. No.: US 2022/0111748 A1
(43) Pub. Date: Apr. 14, 2022

(54) Forced Wind Turbine Charging Device

(71) Applicants: Shane Fresco, Westminster, CO (US); Callie Barker, Westminster, CO (US)

(72) Inventors: Shane Fresco, Westminster, CO (US); Callie Barker, Westminster, CO (US)

(21) Appl. No.: 17/494,037

(22) Filed: Oct. 5, 2021

Related U.S. Application Data
(60) Provisional application No. 63/091,561, filed on Oct. 14, 2020.

(51) Int. Cl. B60L 53/52; F03D 9/32; F03D 3/04; B60L 58/12; H02J 7/34

(52) U.S. Cl. CPC B60L 53/52; F03D 9/32; F03D 3/0409; B60L 58/12; H02J 7/0048; F05B 2220/706; F05B 2240/941; F05B 2240/60; F05D 2300/611; H02J 7/34

(57) ABSTRACT

This present invention relates to a forced wind turbine charging device for use in electric vehicles. The forced wind turbine charging device utilizes an inlet to capture wind which in turn is converted into an electric current to charge the battery of the electric vehicle while the same is in motion, thereby increasing the overall range of the electric vehicle between traditional charges.

### CROSS-REFERENCE TO RELATED APPLICATION

The present application claims priority to, and the benefit of, U.S. Provisional Application No. 63/091,561, which was filed on Oct. 14, 2020 and is incorporated herein by reference in its entirety.

### FIELD OF THE INVENTION

The present invention relates generally to the field of auxiliary power generation systems for electric vehicles. More specifically, the present invention relates to an improved charging device for electric vehicles which features a forced air turbine to convert the incoming air or wind into an electric current for recharging the battery of an electric vehicle. The charging device is a forced air turbine that has an inlet funnel attached to a motor for the conversion of incoming wind energy to electric energy, thereby allowing the batteries of an electric vehicle to be charged by a renewable energy source while the vehicle is in motion. This ability to recharge the batteries on the go permits the user to travel longer distances in an electrically-powered vehicle without stopping at multiple charging stations along the way. Accordingly, the present specification makes specific reference thereto. Nonetheless, it is to be appreciated that aspects of the present invention are also equally applicable to other like applications, devices and methods of manufacture.

### BACKGROUND OF THE INVENTION

By way of background, electric vehicles are becoming an increasingly popular choice of travel for consumers, particularly in view of their lack of reliance on fossil fuels, smaller carbon footprint, decreasing purchase price and their overall benefit to the environment. Historically, electric vehicles work on the basic principle of plugging the electric vehicle into a charging point, and using electricity from the grid to charge the rechargeable batteries that power the electric motor. The charged electric motor provides a motive force to drive the vehicle, and many electric vehicles have been known to be superior to traditional gas or diesel powered vehicles in terms of acceleration, handling and the like. Additionally, the use of electric vehicles also helps reduce fossil fuel consumption, harmful emissions and greenhouse gases (“GHG”) that contribute to climate change and smog, which also improves air quality and overall public health.

Although electric vehicles may be viewed by some as being superior to traditional fossil fuel-based vehicles, the charging of electrically-powered vehicles is dependent upon an infrastructure of electric charging stations which remains somewhat lacking. Additionally, the electricity used to recharge the electric vehicle's batteries at a charging station is still generated from non-renewable energy sources, such as fossil fuels, which can have a negative impact on the environment and the overall public health. Consequently, the “green” value of electric vehicles is somewhat lessened when using a grid or other infrastructure that draws energy from coal, oil and other fossil fuel sources.

Additionally, once the batteries of an electric vehicle are charged, the electric vehicle can typically only travel up to a few hundred miles before requiring a subsequent charge. As noted above, charging stations are not yet as prevalent as they need to be and individuals who use an electrical vehicle must always be mindful of the remaining charge left on the batteries of the electric vehicle. Therefore, the use of electric vehicles has been limited to relatively short commutes and other errands, such as travel to and from a place of employment, or other relatively local destinations. When seeking to travel longer distances, the individual must not only carefully plot his or her course along a route which has suitable charging opportunities, but must also have to stop at multiple charging stations to recharge the vehicle's batteries in order to be able to reach the intended destination. Unfortunately, even when successful in doing so, the individual may be required to spend numerous hours of unproductive downtime at each charging station as most electric vehicle batteries take at least four hours to reach a full charge, while others may take between 15 and 20 hours. Further, if each of the available charging bays are full at a particular charging station, the individual must then have to wait an additional amount of time for an available bay to charge the vehicle's batteries, thereby causing the individual to lose even more time.

Additionally, frequent charging of electric vehicle batteries also adds to the overall expense of owning and operating an electric vehicle as the individual must typically pay for the electricity used to recharge the battery. While many charging stations may offer free charges, many electric car owners also charge the batteries of their electric vehicles at home, which increases the electricity consumption and their overall electricity bills.

Therefore, there exists a long felt need in the art for an alternate or supplemental power generation or charging device for electric vehicles that enables the vehicle to travel longer distances between traditional charges. There is also a long felt need in the art for a vehicle charging device that is not dependent on non-renewable energy sources, and that does not have a negative impact on air quality and/or the environment. Additionally, there is a long felt need in the art for a vehicle charging device that is onboard the electric vehicle and that operates to recharge the vehicle's battery while the vehicle is in motion, thereby eliminating the need to make frequent and lengthy stops at traditional charging stations in order to charge the vehicle, and that increases the overall range of the electric vehicle. Finally, there is a long felt need in the art for an electric vehicle charging device that is relatively inexpensive to manufacture, and both safe and easy to install and use.

The subject matter disclosed and claimed herein, in one embodiment thereof, discloses an onboard forced wind turbine charging device for charging one or more batteries of an electrical vehicle while the vehicle is in motion, thereby extending the range of the vehicle. The charging device is preferably comprised of an air inlet, a wind turbine, a channel extending between the air inlet and the wind turbine, and a generator in communication with each of the wind turbine and the electric vehicle's batteries. The air inlet allows wind/air caused by the vehicle's motion to be directed into the channel and eventually into the wind turbine. The air intake powers the wind turbine which in turn powers the electric generator to generate the electrical current necessary to charge the electric vehicle's batteries while the vehicle is in motion.

In this manner, the novel forced wind turbine charging device of the present invention accomplishes all of the forgoing objectives, and provides a relatively easy, convenient and cost-effective solution to charge an electric vehicle's batteries while on the go and using a renewable energy sources (i.e., the wind caused by the motion of the electric vehicle). The forced wind turbine charging device of the present invention is also user friendly, inasmuch as it does not require users to stop as frequently at charging stations to charge the batteries for their vehicles or wait for long periods of time or availability to do so. The forced wind turbine charging device of the present invention can be retrofitted to existing electric vehicles or integrated into new vehicles at their point of manufacture.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a system for charging one or more batteries of an electrical vehicle. The system uses an inlet for collecting air as the vehicle travels down a roadway or other surface, and a channel for directing the collected air towards a wind turbine. The collected air then causes the wind turbine to rotate, wherein the faster that the electric vehicle is travelling, the faster that the wind turbine will rotate. The wind turbine in turn is in mechanical and electrical communication with a generator, which generates an electrical current from the collected wind energy that is used to recharge the batteries of the electrical vehicle.

In a further embodiment of the present invention, a forced wind turbine charging device configured to be retrofitted or pre-installed in an electric vehicle and used to charge the vehicle's batteries is disclosed. The charging device is comprised of a plurality of wind turbines configured to be rotated by the wind or forced air entering an inlet installed on or near a front grill or other grill or surface of the electric vehicle. In turn, the plurality of wind turbines are in communication with one or more rotors that utilize the harnessed wind energy, convert it to electrical energy and provide the same to recharge the electric vehicle's batteries while the vehicle is in motion.

In yet a further embodiment of the present invention, a method of recharging batteries on an electrical vehicle using incoming wind energy when the vehicle is moving is disclosed. The method comprises the initial steps of capturing air/wind around the vehicle when the vehicle is in motion and directing said forced air/wind to towards one or more wind turbines. Next, the forced air/wind causes the wind turbines to rotate, wherein the amount and speed of rotation is dependent on the amount of forced air/wind collected. The rotation of the wind turbines then causes one or more rotators to rotate and/or power an onboard electrical generator that in turn generates an electrical current. Finally, the electrical current generated by the rotors and/or electrical generator is used to recharge the batteries of the electrical vehicle.

In a still further embodiment of the present invention, a vehicle having an onboard wind energy-based electricity generating system is disclosed. The wind energy-based electricity generating system is comprised of at least one inlet funnel or intake positioned along a front grill or other forward surface of an electrical vehicle to capture surrounding air currents when the vehicle is in motion, a wind or forced air operated turbine that is configured to rotate when the captured air or wind is passed through the turbine and an electricity generating device to produce electricity from the rotating turbine to recharge the batteries of the electric vehicle.

In an alternative embodiment, the inlet funnel may be installed at the rear of the vehicle but at a location to collect incoming air, such as above or below the trunk area of the vehicle. In yet another embodiment, the inlet funnel may be located at both the front and the rear of the vehicle to maximize the amount of wind/forced air harnesses. The charging device of the present invention collects wind or air flow from in front of or over the vehicle's profile and directs the same into a funnel while the vehicle is in motion. The harnesses wind/forced air in turn rotates a wind turbine, rotor and/or motor to generates an electric current that is then used to recharge the vehicle's batteries. In one embodiment, the forced turbine charging system of the present invention is automatically activated when the vehicle is running above a pre-determined or threshold speed, such as 30 km/hr (about 18/mph). In another embodiment, the threshold speed may be higher, such as 40 km/hr (about 25/mph).

The charging device of the present invention allows electrical vehicle owners to use a fully renewable or sustainable energy source (i.e., the wind) to charge the batteries on the vehicle in a more environmentally friendly and efficient manner by avoiding using electricity from a grid that relies upon non-renewable sources of energy, such as fossil fuels. The onboard charging device also prevents individuals from having to stop at multiple charging stations to recharge their vehicle's batteries while traveling, and eliminates the lost time that is associated with the same. Further, the electricity generated by the charging device may not only be used to power the batteries of the electric vehicle, but may also be used for other purposes such as powering other vehicle components or accessories including, without limitation, an electronic device, smartphone, smart watch, tablet, computer or the like.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters or numerals refer to similar parts throughout the different views, and in which:

FIG. 1 illustrates a perspective view of one potential embodiment of an air inlet of the forced air turbine charging device of the present invention installed on the front of a vehicle in accordance with the disclosed architecture;

FIG. 2 illustrates a perspective view of one potential embodiment of an air inlet of the forced air turbine charging device of the present invention installed on the front of a vehicle in accordance with the disclosed architecture and being used to gather wind while the vehicle is in motion;

FIG. 3 illustrates a perspective view of one potential embodiment of a wind turbine of the forced air turbine charging device of the present invention in accordance with the disclosed architecture, wherein the wind turbine is in fluid communication with an air inlet and a channel;

FIG. 4A illustrates a perspective view of one potential embodiment of a forced air turbine charging device of the present invention in accordance with the disclosed architecture, wherein the charging device is retrofitted into an electric vehicle;

FIG. 4B illustrates a perspective view of one potential embodiment of the rotor and blade structure of a forced air turbine charging device of the present invention in accordance with the disclosed architecture;

FIG. 5 illustrates a diagrammatic view of the various components and connections of the forced air turbine charging device of the present invention in accordance with the disclosed architecture; and

FIG. 6 illustrates a perspective view of an alternative embodiment of an air inlet of the forced air turbine charging device of the present invention installed on the front of a vehicle in accordance with the disclosed architecture.

### DETAILED DESCRIPTION OF THEN INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an onboard charging device for an electric vehicle that enables the vehicle to travel longer distances between traditional charges, and that recharges the vehicle's battery while the vehicle is in motion, thereby eliminating the need to make frequent and lengthy stops at traditional charging stations in order to charge the vehicle, thereby increasing the overall range of the electric vehicle. There is also a long felt need in the art for a vehicle charging device that is not dependent on non-renewable energy sources, and that does not have a negative impact on air quality and/or the environment. Finally, there is a long felt need in the art for an electric vehicle charging device that is relatively inexpensive to manufacture, and both safe and easy to install and use.

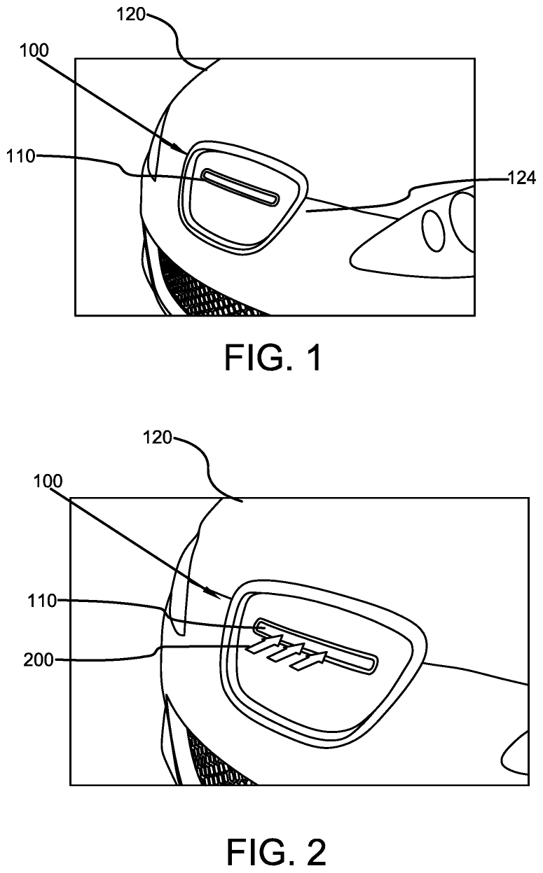

Referring initially to the drawings, FIG. 1 illustrates a perspective view of one potential embodiment of an air inlet of the forced air turbine charging device 100 of the present invention installed on the front of a vehicle in accordance with the disclosed architecture. More specifically, the forced air or wind turbine charging device 100 can be retrofitted or integrated into the front portion of a new or used electric vehicle 120. The charging device 100 is comprised of an inlet 110 to gather or collect the wind flowing over the vehicle 120 from its motion, and direct the same into a channel 310 to convert the force of the incoming wind or air into an electric current to charge the batteries of the electric vehicle 120 while it is in motion. While dependent upon the speed at which the vehicle 120 is travelling, the amount of air or wind flowing over and around the vehicle 120 is typically substantial and worth converting into an electrical current to charge the battery of the vehicle 120. More specifically, and as described more fully below with respect to the remaining figures, the wind captured by the inlet 110 passes through the channel 310 and on to one or more wind turbines 114. The collected and now concentrated wind causes the wind turbines 114 to rotate which in turn powers a generator that creates an electric current that is used to power the vehicle's batteries 400 and/or other components of the vehicle such as, but not limited to, the vehicle's air conditioner 505¹. ¹ Shane/Callie: Do you have any additional technical details on exactly how this would operate that we can include? If so, please redline them directly into this Word document for our review.

In one embodiment, the forced air or wind turbine charging device 100 is installed in the front portion 124 of the vehicle 120. However, depending on the positioning of the electrical batteries 400 of the vehicle 100, the forced wind turbine device 100 can be installed anywhere along the vehicle 120 that is capable of generating enough wind to create the charge necessary to recharge the vehicle's batteries. For example, in FIG. 1 the inlet 110 is positioned along the front grill 124 of the vehicle 120 such that the wind has to travel a shorter distance to the wind turbine 114 so that the volume and speed of the wind does not decrease after entry into the inlet. The inlet tube 110 and/or the channel 310 in fluid communication therewith may also have a volumetric reduction of between 20 and 50 percent from the entry point in order to increase the speed of the wind or air impacting the blades of the wind turbine 114. In one embodiment, the wind energy recharges only the primary electrical batteries of the vehicle 120. However, it is also contemplated that the harnessed wind energy and the electrical current that is created therefrom can also be used to recharge the secondary electrical batteries of the vehicle 120 and/or other vehicle components or user accessories, such as a smartphone.

FIG. 2 illustrates a perspective view of one potential embodiment of an air inlet 110 of the forced air turbine charging device 100 of the present invention installed on the front of a vehicle 120 in accordance with the disclosed architecture and being used to gather wind while the vehicle 120 is in motion. As notes above, the installed forced air or wind turbine charging device 100 is comprised of one or more inlets 110 to receive a flow or forced air or wind 200 flowing over and around the vehicle 120. The wind 200 passes through the inlet 110 and/or channel 310 in which the speed of the wind 200 may be increased by narrowing the area of the passageway before it passes through the wind turbine 114. The wind 200 causes the blades of the wind turbine 114 to rotate which, in turn, powers a motor or generator to create an electrical current that can be used to recharge the vehicle's batteries. In addition, the charging system 100 of the present invention may be in electrical communication with additional outlets 502 in the vehicle 120 so that the owner or operator may also power and/or charge accessories, such as phones, tablets, computers or the like, via the outlets 502 and without depleting the available energy contained in the vehicle's batteries 400.

As stated above, the inlet 110 and channel 310 are configured to increase the velocity of the wind 200 such that the wind 200 reaches the internal wind turbine 114 with a greater velocity than when it first entered the inlet 110 to increase rotation of the blades of the wind turbine 114 and generate more electrical current. For example, in one embodiment, the velocity of the wind 200 may be increased through the Coanda effect². Alternatively, both the Venturi effect and the Coanda effect may be used to increase the velocity of the wind within the charging device 100. Similarly, additional inlets 110 may also be present at one or more locations along the vehicle 120 such as, but not limited to, the rear, sides or roof of the vehicle 120. ² Is this accurate?

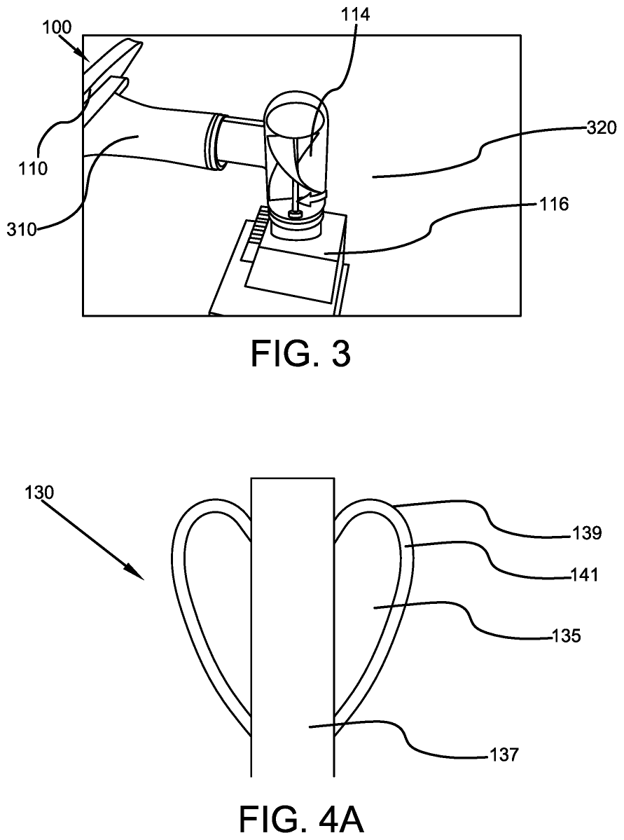

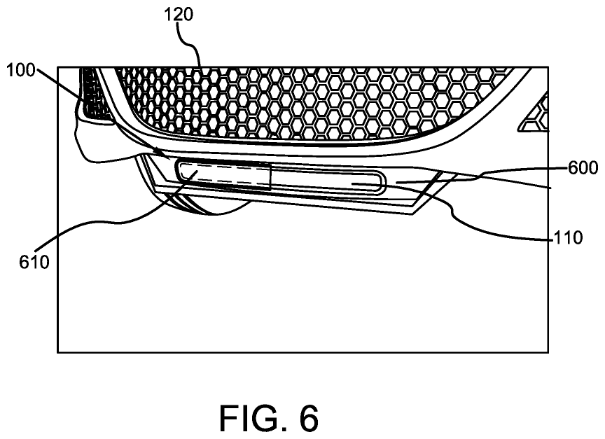

FIG. 3 illustrates a perspective view of one potential embodiment of a wind turbine 114 of the forced air turbine charging device 100 of the present invention in accordance with the disclosed architecture, wherein the wind turbine 114 is in fluid communication with an air inlet 110 and a channel 310. More specifically, the air inlet 110 is connected to the wind turbine 114 through a channel 310, and the air inlet 110 may have a valve or flap 610 (see e.g., FIG. 6) which can control the amount of wind 200 entering the air inlet or to close the air inlet 110 completely so as to not add additional drag to the vehicle 120 when not the charging device 100 is not in use. Within the channel 310, the speed or velocity of the wind 200 is preferably increased by up to 200% of the entry velocity, and the wind 200 having increased velocity rotates the blades of the internal wind turbine 114 in a direction 320.

The internal wind turbine 114 is in turn connected to the electrical power subsystem of the vehicle 120 which produces the electrical energy to recharge the batteries of the electric vehicle 120. Alternatively, the internal wind turbine 114 may have an electric generator to generate the electricity to recharge the batteries. The wind from the inlet 110 enters into the wind turbine 114 through the channel 310. The wind turbine 114 is also comprised of a base 116 that is removably fixed to a surface of the vehicle 120. In one embodiment, the wind turbine 114 may have a plurality of vanes (not shown) rotating around a hub (also not shown).

The channel 310 acts as both a guide for the wind/air collected by the inlet 110 and a constrictor to increase its velocity. The cross-section of the channel is preferably generally circular or elliptical shaped, though other cross-sectional shapes are also contemplated. Each of the channel 310 and the wind turbine 114 can be placed underneath the vehicle 120 so as to not detract from the aesthetics of the vehicle 120, and may be attached to the vehicle's frame for support and easy access, particularly wherein the charging device 100 is added to the vehicle 120 as an aftermarket item. The harnessed wind energy acts as an alternative means to recharging the vehicle's batteries while the vehicle 120 is in motion, which not only saves the owner the time associated with frequenting existing charging stations, but also increases the overall range of the vehicle 120 between traditional charges and makes the charging more environmentally friendly because it does not rely upon the use of fossil fuels. More specifically, the harnessed wind energy is a renewable energy source that is converted into an electrical charge in order to send a trickle charge to the batteries of an electric vehicle. In one embodiment, the electrical current produced by the charging device 100 may first pass through an optional regulator to slowly recharge the batteries.

Additionally, the forced wind turbine charging device 100 may further comprise one or more sensors for sensing the battery level of the vehicle 120, and a cut off mechanism to close off the air inlet 110 once the batteries are recharged completely so as to reduce the aerodynamic drag on the vehicle and improve efficiencies until such time that additional electric current is required by the charging device 100 (e.g., when the batteries require additional charging). In addition, the closing mechanism may not permit the air inlet 110 to open until the vehicle 120 achieves a certain minimum speed (e.g., 40 hm/hr) because it may not be efficient to operate the charging device 100 until such speed has been achieved. For example, the aerodynamic drag on the vehicle 120 caused by the presence of the charging device 100, and the air inlet 110 in particular and its impact on battery usage, may not make it worthwhile to operate the charging device 100 until the minimum vehicle speed has been achieved at which time the air inlet 110 may be automatically opened.

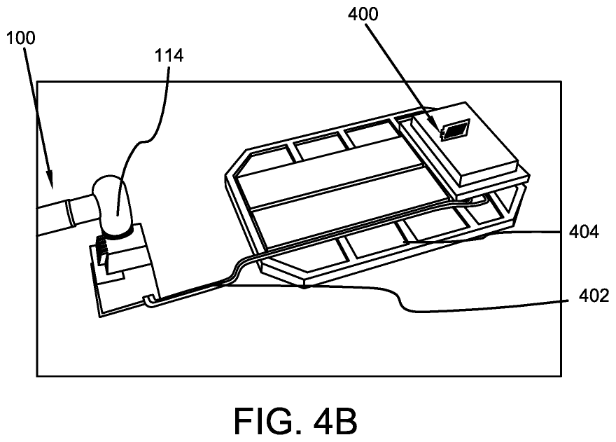

FIG. 4A illustrates a perspective view of one potential embodiment of a forced air turbine charging device 100 of the present invention in accordance with the disclosed architecture, wherein the charging device 100 is retrofitted into an electric vehicle 120. More specifically, the forced wind turbine charged device 100 is connected to a rechargeable battery 400 which is placed on a base 404 and is in electrical communication with the wind turbine 114 via a connector 402 through which the electrical current flows to the rechargeable battery 400. As explained above, the forced wind turbine charging device 100 uses the energy of the harnessed wind 200 which is caused by the relative motion between the vehicle and the wind surrounding it and collected through the inlet 110 to create an electrical charge that can be used to trickle charge the rechargeable battery 400 while the vehicle 120 is in motion.

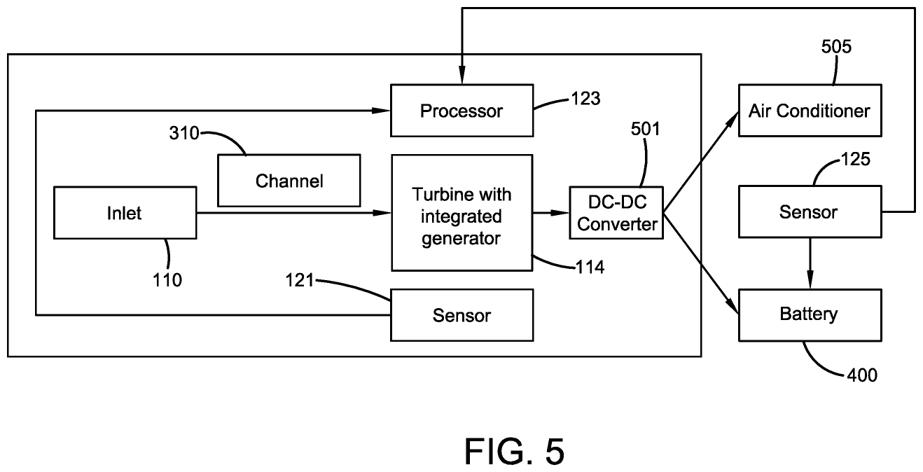

FIG. 4B illustrates a perspective view of one potential embodiment of the rotor and blade structure of a forced air turbine charging device 100 of the present invention in accordance with the disclosed architecture. More specifically, the rotor structure 130 is comprised of an air inlet 133 and a plurality of blades 135 that are attached to a shaft 137, wherein each of the rotor components may be coated with an anti-abrasion coating 139 to prevent debris from the road (e.g. sand, grit, dust, dirt, etc.) and air from damaging the rotor components, which could lead to reduced efficiency of the charging system 100 over time. The anti-abrasion coating 139 may include, but is not limited to, a polyurethane elastomer, graphene based coatings, UV protective materials and the like. In addition, the blades 135 may have additional protection along the leading edge 141 of the blades 135, wherein the thickness of the leading edge may be 10 to 25% greater than the thickness of the remaining portion of the blade 135. Alternatively, the leading edge 141 of the blade 135 may be provided with a polyurethane tape (not shown). The wind turbine/rotor 114, 130 may also be provided with one or more ice sensors 121 (see e.g., FIG. 5) that will detect the build-up of ice which would allow the owner or operator of the vehicle to shut down the charging device 100 (e.g., by closing the air inlet 110) to avoid damaging the device.

FIG. 5 illustrates a diagrammatic view of the various components and connections of the forced air turbine charging device 100 of the present invention in accordance with the disclosed architecture. More specifically, the air inlet 110 receives the incoming air or wind 200 and channels the same towards the wind turbine or rotor 114, 130 in a manner that increases the velocity of the wind 200 once it enters the air inlet 110 or the channel 310. The wind 200, now having an increased velocity, impinges upon blades 135 thereby causing the same and the shaft 137 to rotate. The wind turbine/rotor 114, 130 has an integrated generator to convert the wind energy into electrical energy via the rotation of the shaft 137.

Additionally, the electrical energy is optionally scaled up/down using an AC/DC converter or rectifier 501. The converted DC is used to charge the battery 400 or power other vehicle components, such as the vehicle's air conditioner 505. The charging device 100 may further include one or more sensors 121 which can, in one example, detect ice buildup on the rotor components, heat, wind speed, rotor speed and the like. An additional sensor 125 is provided to give feedback on the amount of charging of the battery 400. Each of the sensors 121, 125 are in communication with a processor 123 that collects data from the sensors 121, 125 and provides the same to the operator of the vehicle 120. In addition, the processor 123 can be used to shut down the charging device 100 (e.g., by closing the air intake 110 in the manner described above) if additional energy is not needed, or if there is too much ice or heat detected anywhere along the charging device 100.

FIG. 6 illustrates a perspective view of an alternative embodiment of an air inlet 110 of the forced air turbine charging device 100 of the present invention installed on the front of a vehicle 120 in accordance with the disclosed architecture. As shown, air inlet 110 is attached to a lower portion 600 of the bumper of the vehicle 120. The air inlet 110 may further include a valve or flap 610 which can be opened or closed depending on whether charging is needed, or in order to protect the internal components from damage (e.g., when there is ice build-up). The flap 610 may be controlled manually or by the processor 123 after receipt from various sensor 121, 125 inputs.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “forced wind turbine”, “forced wind turbine device” and “charging device” are interchangeable and refer to the forced wind turbine charging device 100 of the present invention.

Notwithstanding the forgoing, the forced wind turbine charging device 100 of the present invention and its various components can be of any suitable size and configuration as is known in the art without affecting the overall concept of the invention, provided that it accomplishes the above stated objectives. One of ordinary skill in the art will appreciate that the size, configuration and material of the forced wind turbine charging device 100 as shown in the FIGS. are for illustrative purposes only, and that many other sizes and shapes of the forced wind turbine charging device 100 and its various components are well within the scope of the present disclosure. Although the dimensions of the forced wind turbine charging device 100 and its various components are important design parameters for user convenience, the forced wind turbine charging device 100 and its various components may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A supplemental energy generator for an electric vehicle having a battery, the supplemental energy generator comprising:
an air intake positioned on a body of the electric vehicle to receive a flow of incoming air generated by a movement of the electric vehicle;
a turbine positioned downstream from, and in fluid communication with, the air intake; and
a generator for converting the flow of incoming air to an electric current, wherein the generator is in communication with the turbine and in electrical communication with the battery.

2. The supplemental energy generator as recited in claim 1, wherein the turbine comprises a rotor shaft and a plurality of blades extending outwardly from the rotor shaft, wherein the rotor shaft is rotated when the flow of incoming air impinges upon the plurality of blades.

3. The supplemental energy generator as recited in claim 2, wherein each of the air intake, the plurality of blades and the rotor shaft are coated with an anti-abrasion coating.

4. The supplemental energy generator as recited in claim 3, wherein the anti-abrasion coating is selected from a group consisting of a polyurethane elastomer and a graphene based coating.

5. The supplemental energy generator as recited in claim 2, wherein each of the plurality of blades have a leading edge that is 10 to 25% thicker than a body portion on the plurality of blades.

6. The supplemental energy generator as recited in claim 1 further comprising at least one sensor and a processor.

7. The supplemental energy generator as recited in claim 6, wherein the at least one sensor collects information relating to at least one of the following: a remaining charge of the battery; an ice buildup; a temperature; a speed of a rotor; and a velocity of the flow of incoming air.

8. The supplemental energy generator as recited in claim 6, wherein the air intake further comprises a flap for controlling the flow of incoming air.

9. The supplemental energy generator as recited in claim 8, wherein the flap is controlled by the processor.

10. The supplemental energy generator as recited in claim 1, wherein the air intake has a volumetric reduction of between 20 and 50 percent between an entry point of the air intake and the turbine.

11. The supplemental energy generator as recited in claim 1, wherein the air intake increases a velocity of the flow of incoming air by up to 200% before the flow of incoming air reaches the turbine.

12. A charging device for use with a battery installed in an electric vehicle, the charging device comprising:
a wind intake positioned on at least one of a front, a rear, a top or a bottom of the electric vehicle to collect a flow of incoming air;
a channel in fluid communication with the wind intake and having an ingress and an egress, wherein the ingress is between 20 and 50 percent larger than the egress;
a turbine having a rotor shaft and a plurality of blades, wherein the turbine is in fluid communication with the egress of the channel;
at least one sensor attached to the turbine; and
a processor in communication with the at least one sensor.

13. The charging device as recited in claim 12, wherein the at least one sensor collects information relating to at least one of the following: a remaining charge of the battery; an ice buildup; a temperature; a speed of the rotor shaft; and a velocity of the flow of incoming air.

14. The charging device as recited in claim 13, wherein a second sensor collects information on a second one of the following: the remaining charge of the battery; the ice buildup; the temperature; the speed of the rotor; and the velocity of the flow of incoming air.

15. The charging device as recited in claim 12, wherein the wind intake, the plurality of blades and the rotor shaft are coated with an anti-abrasion coating

16. The charging device as recited in claim 15, wherein the anti-abrasion coating is selected from a group consisting of a polyurethane elastomer and a graphene based coating.

17. The charging device as recited in claim 12, wherein the wind intake is comprised of an intake control valve.

18. A charging device for charging a battery of an electric vehicle while the electric vehicle is in motion, wherein the charging device comprises:
an energy generator comprised of a turbine, a generator, at least one sensor and a current converter; and
a wind intake positioned on an exterior surface of the electric vehicle for directing a flow of wind to the turbine, wherein the turbine comprises a rotor shaft and a plurality of blades.

19. The charging device as recited in claim 18 further comprising a processor in communication with the at least one sensor.

20. The charging device as recited in claim 19, wherein the wind intake comprises a flap in communication with the processor.
